(19) United States
(12) Patent Application Publication
(10) Pub. No.: US 2022/0142207 A1
(43) Pub. Date: May 12, 2022

(54) METHOD AND MEANS FOR PROCESSING BEVERAGES

(71) Applicant: STONE TREE INTERNATIONAL LIMITED, London (GB)

(72) Inventors: Paul Bertus HAYES, Stellenbosch (ZA); Timothy John BOND, Bedford (GB)

(21) Appl. No.: 17/438,559

(22) PCT Filed: Mar. 11, 2020
(86) PCT No.: PCT/IB2020/052108

§ 371 Date: Sep. 13, 2021

(30) Foreign Application Priority Data
Mar. 13, 2019 (ZA) 2019/01552

(51) Int. Cl. A23L 2/44

(52) U.S. Cl. CPC A23L 2/44

(57) ABSTRACT

The invention discloses a method for the manufacture of a naturally preserved beverage that is substantially free from—, or substantially reduced in supplementary (added) sulphur compounds—, or containing combined levels of supplementary sulphur— and/or other preservation compounds, which includes the steps of providing a suitable beverage substrate to suitable processing vessel; of undertaking suitable treatment of the substrate within the processing vessel; of adding suitable plant material to the substrate prior to—and/or during and/or post suitable treatment to render a naturally preserved beverage that is substantially free from—, or substantially reduced in supplementary (added) sulphur compounds—, or containing combined levels of supplementary sulphur—and/or other preservation compounds. The beverage substrate is of fruit and/or vegetable and/or grain origin.

### FIELD OF INVENTION

The present invention relates to a method and means for processing beverages.

More particularly, the present invention relates to a method and means for processing beverages, including an improved method for the manufacture of alcoholic and/or other beverages, products produced by such process, and an improved process for preservation of alcoholic (e.g. wines, beers, ciders) and/or other beverages

### BACKGROUND TO INVENTION

In the beverage industry, sulphur compounds are commonly used as preservative. In the alcoholic beverage industry, these compounds may be added prior to—, during—and/or following the fermentation process, as the final quality of a beverage, is dependant, amongst others, on its oxidative status.

Sulphites are sulphur compounds that occur naturally in grapes, hops and apples, the raw materials conventionally used to make wine, beer and cider. In general, sulphites prevent the growth of bacteria which may lead to beverages becoming cloudy or turning the alcohol to vinegar over time. However, the levels of naturally occurring sulphur compounds are too low, so extra sulphites are added as a preservative to most wines, beers, as well as ciders.

The processes for the manufacture of various alcoholic beverages are well known to those skilled in the art—as briefly illustrated below in the case of red wine.

The winemaking process starts with red wine grape cultivars that are harvested, destemmed, crushed and thereafter fermented. Following fermentation, the wine is racked off (fruit/fermentable solids) and may (depending on type of wine) undergo secondary fermentation step, where the wine is aged/matured over time, usually six to eighteen months for red wines.

As stated, a sulphur source as preservative is added prior to—, during—and/or following the wine making process, to prevent oxidation. A conventional preservative is sulphur dioxide. The purpose of the sulphur source is twofold; acting as an anti-microbial agent and protecting the wine from oxidation which would be detrimental to the wine product.

Although the addition of sulphur to wine is a necessary step, it is also contentious, as it may have a detrimental effect on certain types of consumers, especially intolerance/allergy-prone individuals with a sensitivity to the presence of sulphur compounds present in wine.

Sulphur compounds may also impart an unpleasant taste to a wine, but notably, sulphur compounds have a significant masking effect on (especially) fruity flavours, as well as taste and/or mouthfeel, thereby undermining or weakening the true character, flavour and taste profile of wine.

In addition, sulphur compounds (e.g. sulphur dioxide—SO₂) in beverages consists of free SO₂ and bound SO₂. The free SO₂ fraction in wine and other beverages has the most antimicrobial and anti-oxidative activity, but it is volatile and unstable. If, during manufacture, a beverage is not kept within a 100% impermeable barrier, free SO₂ escapes and the antioxidant (SO₂) diminishes as a preservative or antioxidant and thus it is common practice to “top it up” during the wine-making process (within permissible levels) to prevent oxidation. In addition, if a final beverage is packaged in material that is not 100% impermeable, the free SO₂ would permeate through the packaging (material) and the beverage would be susceptible to spoilage.

Furthermore, once a container of wine—bottle or bulk packaging (e.g. Bag-in-Box type) is opened, air/oxygen can be entrained, the free SO₂ readily escapes and the preservative effect is lost, thus the wine oxidises and becomes tainted/spoiled.

Similar to the red wine example above, other alcoholic beverages (including white wines, beers and ciders) and also other beverages are conventionally subjected to the practice of addition of sulphur compounds (or potentially other preservatives) during the production of these beverages and they share the same challenges that red wine does.

Within the beverage industry, there are several botanicals or derivatives thereof that claim efficacy as a natural preservative in comparison to SO₂. However, at their prescribed dosage rates, efficacy may be limited. Higher dosages (although possible) conventionally imparts additional colour—and/or taste changes to the beverage, thus altering the appearance, taste or character of the beverage. In addition, these botanicals or their derivatives have not been specifically processed or treated to prevent or minimise taste and/or colour changes taking place within the plant material itself, or within final beverage application and thus over time, colour and taste changes take place, thereby altering the (original) taste or character of the beverage. This is most noticeable with light-coloured beverages, e.g. beers, white wines and ciders. In some instances, botanicals are specifically subjected to treatments intended to contribute to taste and/or colour, such as toasting to impart a caramel taste. As a result, sulphur compounds still remain the “preservative of choice” for most beverages even in the instance where botanicals that have a natural preservative action have been added to a beverage.

It is the object of this invention to suggest a completely natural method to preserve beverages as an alternative to sulphur compounds that are traditionally used for the preservation of alcoholic—, as well as other beverages.

It is also an object of this invention to suggest a completely natural method for substantially reducing sulphur-base compounds in alcoholic—, as well as other beverages in order to produce beverages endorsed as “Reduced sulphur content” beverages.

It is another object of this invention to suggest a completely natural antioxidant to preserve the chemical composition of the beverage components which may be used in conjunction with supplementary sulphur—and/or other preservation compounds.

It is also an object of this invention to suggest a non-volatile, natural preservative that is barrier-stable to permeation.

It is a further object of this invention to suggest a method which enhances the shelf life of alcoholic—and/or other beverages.

It is another object of this invention to suggest a non-volatile, natural preservative that protects the portion of beverage within a container following partial consumption thereof.

It is a further object of this invention to suggest a method which enhances the flavour—and/or taste profile (including mouthfeel) of alcoholic—and/or other beverages.

It is still a further object of this invention to suggest a method which protects the natural colour of alcoholic—and/or other beverages.

It is also an object of this invention to suggest a method to produce beverages that can be certified/labelled “Preservative Free”.

It is also an object of this invention to suggest a method to produce beverages that can be certified/labelled “Organic”.

It is also an object of this invention to suggest a method to produce an additive/process aid that can be positioned as a “Clean Label” option (not requiring labelling).

It is also an object of this invention to suggest a method to produce beverages that may be healthier than those conventionally preserved with sulphur compounds.

It is another object of this invention to suggest a method for processing the plant material that forms the basis of the completely natural antioxidant and non-volatile preservative to preserve the chemical composition of the beverage components and/or which is barrier-stable to permeation.

It is also an object of this invention to suggest an efficacious dosage or inclusion rate of the completely natural antioxidant and non-volatile preservative in accordance with this invention.

### SUMMARY OF INVENTION

According to the invention, a method for the manufacture of a naturally preserved beverage that is substantially free from—, or substantially reduced in supplementary (added) sulphur compounds—, or containing combined levels of supplementary sulphur—and/or other preservation compounds includes the steps of providing a suitable beverage substrate to suitable processing vessel; of undertaking suitable treatment of the substrate within the processing vessel; of adding suitable plant material to the substrate prior to—and/or during and/or post suitable treatment to render a naturally preserved beverage that is substantially free from—, or substantially reduced in supplementary (added) sulphur compounds—, or containing combined levels of supplementary sulphur—and/or other preservation compounds.

The beverage substrate may be of fruit and/or vegetable and/or grain origin.

The substrate may be fresh and/or processed.

The substrate may be a sugar and/or a starch.

The treatment may be fermentation.

The treatment may be heating and/or cooling.

The treatment may be separation, e.g. fining, clarification or filtration.

The treatment may be pasteurization or sterilization.

The treatment may be packaging, e.g. bottling or canning.

Also according to the invention, a method for the manufacture (processing) of plant material to be used in accordance with this invention in the manufacture of a naturally preserved beverage may be subjected to one or more treatment step(s) to retain and/or augment desired phytochemical characteristics.

The treatment step may be enzyme deactivation/inactivation.

The enzyme deactivation may be accomplished by heating.

The heating may be direct, e.g. steam treatment.

The heating may be indirect, e.g. microwaves.

The treatment step may be drying.

The treatment step may be stress induction.

The stress induction may be light/UV treatment.

The desired phytochemical characteristics may be antioxidant or enhanced antioxidant activity.

The desired phytochemical characteristics may be colour stability.

The plant material may be of the plant family Theaceae.

The plant material may be of the plant family Aquifoliaceae.

The plant material may be of the plant family Fagaceae.

The plant material may be of the plant family Lamiaceae.

The plant material may be of the plant family Apiaceae.

The plant material may be of the plant family Poaceae.

The plant material may be of the plant family Rubiaceae.

The plant material may contain simple phenolics and/or polyphenolic components classified as hydrolysable—or condensed tannins, and the repeat chemical units that make them up, generally referred to as “total polyphenols”. Exact structures and nomenclature of these are available in literature and they act as antioxidants and/or preservatives.

The plant material may be de-flavoured or de-aromatized.

The plant material may be processed to enhance the bioavailability of components within the plant material.

The plant material may be processed or augmented into a comminute, extract, derivative or infusion of plant material.

The method may include the increase or decrease of chemical components from plant material and/or substrate and/or beverage.

The method may include a processing aid to assist in the dosing and/or dispersion of plant material or plant material derivative (e.g. extract).

The processing aid may assist in preventing oxidation or degradation of the beverage.

The method may include addition to—, or removal of alcohol to the substrate and/or beverage to render a fortified—or low alcohol—or de-alcoholised beverage.

The naturally preserved beverage may contain natural preservatives and/or antioxidants originating from the plant material which acts as alternative to sulphur compounds traditionally used for the preservation of alcoholic, as well as other beverages.

The natural preservatives and/or antioxidants may be non-volatile and barrier-stable to permeation.

The natural preservatives and/or antioxidants may enhance the existing flavour—and/or taste profile (including mouthfeel) of alcoholic—and/or other beverages.

The natural preservatives and/or antioxidants may protect the natural colour of alcoholic—and/or other beverages.

The natural preservatives and/or antioxidants may extend a natural colour to alcoholic—and/or other beverages.

The natural preservatives and/or antioxidants may enhance the shelf life of alcoholic—and/or other beverages.

The natural preservatives and/or antioxidants may produce beverages that can be certified/labelled “Preservative Free”.

The natural preservatives and/or antioxidants may produce beverages that can be certified/labelled “Organic”.

The natural preservatives and/or antioxidants may produce beverages that can be positioned “Clean Label”.

The natural preservatives and/or antioxidants may render a healthier beverage than those conventionally preserved with sulphur compounds.

Also according to the invention, a processing plant for the manufacture of a naturally preserved beverage that is substantially free from added sulphur compounds—, or substantially reduced in supplementary (added) sulphur compounds—, or a naturally preserved beverage containing combined levels of supplementary sulphur—and/or other preservation compounds include suitable processing vessel where suitable beverage substrate can undergo suitable treatment; plant material supply means for supplying suitable plant material to the beverage substrate and/or processing vessel; and transfer means to transfer the beverage that is substantially free from added sulphur compounds—, or substantially reduced in supplementary (added) sulphur compounds—, or containing combined levels of supplementary sulphur—and/or other preservation compounds onto further processing.

The processing vessel may be a container, e.g. tank or vat.

The processing vessel may be a pipe.

The processing vessel may be a receptacle, e.g. bottle, can or other packaging.

The processing vessel and plant material supply means may be combined.

The preferred dosage of total polyphenols originating from plant material (or derivative, i.e. extract) may be between 2.5 mg and 5000 mg per litre at final beverage dilution as measured using the Folin-Ciocalteu (“F-C”) method.

The more preferred dosage of total polyphenols originating from plant material (or derivative i.e. extract) may be between 25 mg and 1500 mg per litre at final beverage dilution as measured using the F-C method.

The most preferred dosage of total polyphenols originating from plant material (or derivative i.e. extract) may be between 50 mg and 750 mg per litre at final beverage dilution as measured with F-C method.

The processing plant may include further processing means conventionally found in the beverage industry, including heating and cooling means, agitation means, comminution means, fining—, filtration—and separation means, filling means, alcohol standardisation means to add—or remove alcohol to render a fortified, low alcohol or alcohol free beverage, means to lower or remove chemical components from suitable plant material, substrate or beverage etc.

The processing arrangement may include heating and/or cooling means.

The processing arrangement may include agitation means.

The processing arrangement may include separation (e.g. fining/racking/filtration/centrifugation) means.

The processing arrangement may include filling means.

The processing arrangement may include alcohol standardisation means to add—or remove alcohol to render a fortified, low alcohol—or alcohol—free beverage.

The processing arrangement may include means to lower or remove chemical constituents from plant material, substrate, or beverage.

Also according to the invention, the processing plant and/or processing arrangement for the manufacture of plant material to be used in accordance with this invention may include means to treat plant material to retain and/or augment desired phytochemical characteristics of the plant material including direct heating means for enzyme deactivation within the plant material (which may include steam and/or hot water) or indirect heating means for enzyme deactivation within the plant material (which may include microwave or similar technological means); stress induction means for enhancing or augmenting the antioxidative levels within plant material; comminution means as well as further processing means conventionally associated with the tea, herbals and plant processing, including extraction and further processing industries (including physical separation and drying), which may also include means to lower or remove chemical components from plant material and/or extracts thereof.

### DETAILED DESCRIPTION OF THE INVENTION

The invention will now be described by way of example and embodiments. These embodiments are not to be limited in terms of the particular embodiments described, nor dosage or type of plant material used. Furthermore, due to the fact that phytochemical actives/constituents may vary between different plant species as well as different physiological parts of the plant material itself (e.g. leaf vs stalk), these dosage levels are not to be interpreted as a minimum or maximum value are intended only as illustrations of various aspects. In addition, different types of beverages (alcoholic and/or non-alcoholic) may have different preservative—, antioxidant—or taste requirements, which implies a need for higher or lower dosages. And as a result, many modifications and variations can be made without departing from the spirit or scope of the invention including application of this invention within the soft drink industry

According to a first embodiment of the invention there is provided an improved process for the manufacture of a red wine that is substantially free from added sulphur compounds.

Pinotage grapes were harvested, de-stemmed and crushed to render a must which is subjected to primary fermentation in a stainless-steel vessel. Suitable oenological yeast is added per fermentation specification, whilst 1.5 g of finely ground unfermented plant material of the plant family Aquifoliaceae with a soluble content of approximately 12.5% antioxidants per gram of plant material is also added per litre of must during this step of primary fermentation. During this time plant polyphenols and Phyto-components are extracted from both grape skins, as well as plant material from the plant family Aquifoliaceae.

At the onset of a 9 month secondary fermentation/maturation step, 2.0 g of finely ground unfermented, enzyme deactivated plant material of the plant family Theaceae with a content of approximately 15% soluble antioxidants per gram of plant material is added per litre of wine in second-fill oak barrels. During this time, plant polyphenols and Phyto-components are also extracted from plant material from the plant family Theaceae.

Following the maturation step, the wine is conventionally processed (filtered etc.) and bottled, but without the addition of any sulphur compounds to render a Pinotage wine that is free from added sulphur compounds. The total antioxidant dosage added to the beverage amounts to 480 mg per litre (1.5 g×12%+2 g×15%/1000).

12 months following bottling, the wine is compared to a “Control” that contains sulphites. Both wines appear similar in terms of colour. The sulphite-free wine is notably fruity with a well-defined nose as well as a very pleasant mouthfeel, which is indicative of protection against oxidation.

According to a second embodiment of the invention there is provided an improved process for the manufacture of a white wine that is substantially free from added sulphur compounds.

Sauvignon Blanc grapes were harvested, de-stemmed and crushed to render a must that is cold settled and racked in a stainless-steel vessel. Suitable oenological yeast is added per fermentation specification, whilst special care is taken to prevent oxidation of must by using a carbon dioxide blanket to block oxygen from coming into contact with the must.

Following fermentation, 1.0 g of unfermented (non-aerated), decaffeinated extract of the plant family Theaceae with a water-soluble content of approximately 30% antioxidants per gram of extract is added per litre. The wine is conventionally processed, i.e. racked off, cold—and protein stabilized and thereafter filtered, before being bottled, but without the addition of any sulphur compounds to render a Sauvignon Blanc wine that is free from added sulphur compounds. The total antioxidant dosage added to the beverage amounts to 300 mg per litre (1×30%/1000).

3 months following bottling, the wine is compared to a “Control” that contains sulphites. Both wines appear very similar in colour. However, the sulphite-free wine has a markedly fruity nose. Mouthfeel and taste of the sulphite-free wine is also “clean and crisp” in character, indicating protection against oxidation.

According to a third embodiment of the invention there is provided an improved process for the manufacture of a Beer (Pale Ale) that is substantially free from added sulphur compounds.

An 80%/20% mixture of barley and wheat is malted and mashed in the conventional manner to render a wort. The conventional amount of hops is decreased by 50% to produce a less bitter beer. In addition to the hops, 1.5 g of finely ground, decaffeinated and unfermented plant material of the plant family Theaceae with a hot water soluble content of approximately 13% soluble antioxidants per gram of plant material is added per litre of wort, thereby increasing the protective characteristics rendered by the phytochemicals conventionally present within the hops.

Following an hour-long boil, the wort is conventionally cooled, strained and filtered and transferred to a fermentation vessel where commercial yeast is added to initiate fermentation of the sugar to alcohol.

Following fermentation, the substantially uncarbonated beer is (artificially) carbonated and bottled. One month following bottling, the naturally preserved beer with a total antioxidant dosage added to the beverage amounts to 195 mg per litre (1.5 g ×13%/1000) is compared to a “Control” that contains sulphites. Both appear very similar in colour, but the sulphite-free beer has a very pleasant, notably less bitter, but still “crisp” taste in comparison to the sulphite-containing control.

According to a fourth embodiment of the invention there is provided an improved process for the processing, packaging and preservation of bag-in-box “BIB” type beverages with enhanced barrier-stability than preservation by sulphur compounds alone.

Three different Sauvignon Blanc wines (which already contain sulphur dioxide as antioxidant/preservative) are blended in equal parts with each other for packaging into BIB containers.

30 grams of a filtered extract containing 7.5% antioxidants on a dry basis of the plant family Theaceae (which had been extracted within a 70% water/30% alcohol mixture) is added per litre of the blend and packaged as BIB. The total antioxidant dosage added to the beverage thus amounting to 225 mg per litre (30 g×7.5% / 1000). 2 treated—and 2 untreated BIBs are thereafter subjected to 24 months accelerated storage, where one week at 30 degree C. equals 1 month storage at room temperature and the wine containing the 7.5% extract of the plant family Theaceae is compared to a “Control” which had not been supplemented with the extract of the plant family Theaceae.

The control has a markedly “flat” nose and slightly tainted taste in comparison to the beverage containing the extract of the plant family Theaceae, indicating that oxidation had taken place within the Control, whilst the wine containing the extract of the plant family Theaceae had been substantially preserved.

According to a fifth embodiment of the invention there is provided an improved process for extending the shelf life of a packaged beverage following opening and partial consumption thereof and comparison to a non-opened beverage.

Three identical 3 litre BIB Sauvignon Blanc wines (which already contain sulphur dioxide as antioxidant/preservative) are purchased, 2 BIBs are subjected to the following treatment:

Into one corner of a BIB #1 bag (Control) is injected via hypodermic needle 3×30 ml of a 70% water/30% alcohol mixture only, the corner is immediately sealed to prevent any leakage or oxygen ingress.

Into one corner of a BIB #2 bag is injected via hypodermic needle 3×30 ml of a 5% filtered extract containing approximately 5% soluble antioxidants made by extracting a 50/50 blend of unfermented, enzyme deactivated plant material from the plant families Theaceae and Aquifoliaceae within a 70% water/30% alcohol mixture, the corner immediately sealed to prevent any leakage or oxygen ingress. The total antioxidant dosage added to the beverage thus amounting to 150 mg per litre (30 g×5%/1000).

2 weeks following treatment the two treated BIBs are subjected to an initial tasting with 7 subsequent tastings at one-week intervals to assess the wines over an eight-week period.

BIB #2 (treated) outperforms BIB #1 (Control) on taste, freshness, fruitiness as well as mouthfeel from the onset of the trial and for the duration of all the tastings over the eight-week period.

By week 4 there is a slight oxidative taste in BIB #1, attributed to oxidation taking place as a result of oxygen ingress when decanting a glass from BIB and an inability of SO2 to scavenge the oxygen. Oxidation of BIB #1 is even more noticeable by weeks 5-7, whilst no oxidation is perceived in BIB #2 indicating a very potent antioxidant capability attributed to the plant material.

By week 8, BIB #3 (unopened) is opened and compared to BIB #1 and BIB #2 with the following results. BIB #1 has a marked oxidative taste. BIB #2 has no discernible oxidative taste and is perceived as being on par to BIB #3 which has just been opened in terms of freshness, fruitiness and mouthfeel.

According to a sixth embodiment of the invention there is provided an improved process for extending the shelf life of a packaged beverage following opening and partial consumption thereof as well as comparison to a non-opened beverage.

Three identical 750 ml Shiraz bottles fitted with screw caps (which already contain sulphur dioxide as antioxidant/preservative) are purchased.

Approximately half (375 ml) of two of the bottles are conventionally decanted. One bottle is thereafter closed by screwing the cap in place (Control). The other bottle is treated by addition of a 500 mg pelletized lozenge containing 300 mg of a spray dried extract of unfermented, enzyme deactivated plant material from the plant family Theaceae containing approximately 35% soluble antioxidants, The lozenge also contains 100 mg maltodextrin (as bulking—) and 100 mg effervescent powder (as dissolution agent). The effervescent powder, when coming into contact with the wine assists with the dissolution of the lozenge and as by-product also creates a small blanket/headspace of CO₂ thereby assisting in preventing oxidation. All bottles are thereafter stored upright, at room temperature.

Seven days later, all three bottles are re-opened and tasted. The untreated (Control) has lost freshness and tastes “stale—a sign of oxidation. The treated bottle with a total antioxidant dosage added to the beverage of 380 mg per litre (300 mg×35%/375 ml) has a marked improvement in comparison to the untreated (Control) and compares very favourably to the unopened bottle.

According to a seventh embodiment of the invention there is provided a differently processed plant materials of the same species to illustrate the importance of correct processing conditions for this invention to produce a beverage that is substantially free from added sulphur compounds.

Sauvignon Blanc grapes were harvested, de-stemmed and crushed and transferred into three stainless steel tanks. Special care is taken to prevent oxidation of must by using a carbon dioxide blanket to block oxygen from coming into contact with the juice.

To tank 1 is added 0.5 g of finely milled enzyme deactivated dried plant material of the family Theaceae, containing 12% antioxidants per gram as measured by F-C method.

To tank 2 is added 0.6 g of finely milled non-enzyme deactivated dried plant material of the plant family Theaceae, containing 10% antioxidants per gram as measured by F-C method.

Tank 3 is processed per conventional method, utilising sulphur compounds as preservative.

The must is cold settled and thereafter racked, whilst suitable oenological yeast is added per fermentation specification to each tank.

Following fermentation, the tanks are treated as follows:

To tank 1 is added another 0.5 g of finely milled, enzyme deactivated dried plant material of the family Theaceae, containing 12% antioxidants per gram as measured by F-C method. The total antioxidant dosage to the beverage thus amounts to 120 mg per litre [(0.5×12% +0.5×12%)/1000].

To tank 2 is added another 0.6 g of finely milled non-enzyme deactivated dried plant material of the plant family Theaceae, containing 10% antioxidants per gram as measured by F-C method. The total antioxidant dosage to the beverage in tank 2 also amount to 120 mg per litre [(0.6×10%+0.6×10%)/1000].

The three tanks are thereafter conventionally processed, i.e. racked off, cold—and protein stabilized and thereafter filtered, before being bottled, to render 3 different Sauvignon Blanc wines.

6 months following bottling, the three wines are compared, Tank 3 being the “Control” that contains sulphites and the results are as follows: Wine from Tank 1 (enzyme deactivated plant material) appear very similar in colour to the Control. Wine from Tank 2 (non-enzyme deactivated plant material) has a notably darker appearance to both Tank 1 as well as the Control, which is undesirable from a colour perspective. Regarding taste, Wine from Tank 1 has a fresher (crispier) and more fruity taste than Control. Wine from Tank 2 has a notably different taste (not unpleasant) but not befitting the character of this cultivar.

1.-60. (canceled)

61. A method for the manufacture of a naturally preserved beverage that is substantially free from—, or substantially reduced in supplementary (added) sulphur compounds—, or containing combined levels of supplementary sulphur—and/or other preservation compounds, which includes the steps
a. of providing a beverage substrate to a processing vessel;
b. of undertaking treatment of the substrate within the processing vessel;
c. of adding plant material to the substrate prior to—and/or during and/or post treatment to render a naturally preserved beverage that is substantially free from—, or substantially reduced in supplementary (added) sulphur compounds—, or containing combined levels of supplementary sulphur—and/or other preservation compounds.

62. The method as claimed in claim 61, in which the beverage substrate is of fruit and/or vegetable and/or grain origin, and/or fresh and/or processed and/or a sugar and/or a starch.

63. The method as claimed in claim 61, in which the treatment is fermentation and/or heating and/or cooling and/or separation and/or fining and/or clarification and/or filtration and/or pasteurization and/or sterilization and/or packaging.

64. The method as claimed in claim 61, in which the plant material is subjected to at least one treatment step(s) to retain and augment desired phytochemical characteristics.

65. The method as claimed in claim 64, in which the treatment step is enzyme deactivation/inactivation.

66. The method as claimed in claim 65, in which the enzyme deactivation is accomplished by heating.

67. The method as claimed in claim 64, in which the treatment step is at least one selected from the group consisting of drying and stress induction.

68. The method as claimed in claim 67, in which the stress induction is light/UV treatment.

69. The method as claimed in claim 64, in which phytochemical characteristics is at least one selected from the group consisting of antioxidant activity, enhanced antioxidant activity and color stability.

70. The method as claimed in claim 61, in which plant material is at least one selected from the group consisting of the plant family Theaceae, the plant family Aquifoliaceae, the plant family Fagaceae, the plant family Lamiaceae, the plant family Apiaceae, the plant family Poaceae, and the plant family Rubiaceae.

71. The method as claimed in claim 61, in which the plant material contains simple phenolics and/ polyphenolic components classified as hydrolysable—or condensed tannins, and the repeat chemical units that make them up, generally referred to as “total polyphenols” that act as antioxidants and preservatives.

72. The method as claimed in claim 61, in which the plant material is de-flavored, de-aromatized, processed to enhance the bioavailability of components within the plant material and processed and augmented into a comminute, extract, derivative or infusion of plant material.

73. The method as claimed in claim 61, which includes a processing aid to assist in the dosing and/or dispersion of plant material or plant material derivative and the addition to—, or removal of alcohol to the substrate or beverage to render a fortified—or low alcohol—or de-alcoholized beverage.

74. A naturally preserved beverage, which contains natural preservatives and/or antioxidants originating from plant material which acts as alternative to sulphur compounds traditionally used for the preservation of alcoholic, as well as other beverages.

75. A naturally preserved beverage as claimed in claim 74, which contains at least one natural preservatives and/or antioxidants selected from the group consisting of that are non-volatile and barrier-stable to permeation, that protect the natural color of beverages and that extend a natural color to beverages and that enhance the shelf life of beverages and that can be certified/labelled “Preservative Free” and that can be certified/labelled “Organic” and that produce beverages that can be positioned “Clean Label” and that render a healthier beverage than those conventionally preserved with sulphur compounds and that with a preferred dosage of total polyphenols originating from plant material (or derivative, i.e. extract) of between 2.5 mg and 5000 mg per liter at final beverage dilution as measured using the Folin-Ciocalteu (“F-C”) method and that are a more preferred dosage of total polyphenols originating from plant material of between 25 mg and 1500 mg per liter at final beverage dilution as measured using the Folin-Ciocalteu (“F-C”) method and that with a most preferred dosage of total polyphenols originating from plant material of between 50 mg and 750 mg per litre at final beverage dilution as measured using the Folin-Ciocalteu (“F-C”) method.

76. A processing plant for the manufacture of a naturally preserved beverage that is substantially free from added sulphur compounds—, or substantially reduced in supplementary (added) sulphur compounds—, or a naturally preserved beverage containing combined levels of supplementary sulphur—and/or other preservation compounds include a processing vessel where beverage substrate can undergo treatment; plant material supply means for supplying plant material to the beverage substrate and/or processing vessel; and transfer means to transfer the beverage that is substantially free from added sulphur compounds—, or substantially reduced in supplementary (added) sulphur compounds—, or containing combined levels of supplementary sulphur—and/or other preservation compounds onto further processing.

77. A processing plant as claimed in claim 76, in which the processing vessel and plant material supply means are combined.

78. A processing plant for the manufacture of a naturally preserved beverage that is substantially free from added sulphur compounds—, or substantially reduced in supplementary (added) sulphur compounds—, or a naturally preserved beverage containing combined levels of supplementary sulphur—and/or other preservation compounds also includes further processing means conventionally found in the beverage industry, including heating and cooling means, agitation means, comminution means, fining—, filtration—and separation means, filling means, alcohol standardization means to add—or remove alcohol to render a fortified, low alcohol or alcohol free beverage, means to lower or remove chemical components from suitable plant material, substrate or beverage.

79. A processing plant for the manufacture of plant material in accordance with the method of claim 1, said plant comprises means to treat plant material to retain and augment desired phytochemical characteristics of the plant material including direct heating means for enzyme deactivation within the plant material, including steam and/or hot water or indirect heating means for enzyme deactivation within the plant material, including microwave or similar technological means; stress induction means for enhancing or augmenting the antioxidative levels within plant material; comminution means as well as further processing means conventionally associated with the tea, herbals and plant processing industries, including extraction and further processing (including physical separation and drying); means to lower or remove chemical components from plant material and/or extracts thereof.
